(19) United States
(12) Patent Application Publication
(10) Pub. No.: US 2020/0315180 A1
(43) Pub. Date: Oct. 8, 2020

(54) SOIL METABOLIZABLE CYANAMIDE PESTICIDE COMPOSITIONS

(71) Applicants: Metbro Distributing L.P., Fresno, CA (US); Auburn University, Auburn, AL (US)

(72) Inventor: Rodrigo RODRIGUEZ-KABANA, Auburn, AL (US)

(21) Appl. No.: 16/861,322

(22) Filed: Apr. 29, 2020

Related U.S. Application Data
(62) Division of application No. 14/783,626, filed on Oct. 9, 2015.
(60) Provisional application No. 61/811,381, filed on Apr. 12, 2013.

(51) Int. Cl. A01N 59/24; A01N 25/00

(52) U.S. Cl. CPC A01N 59/24; A01N 25/00

(57) ABSTRACT

Compositions of cyanamide and polyhydroxy organic compounds are provided, along with urea compositions. These compositions can be used for controlling the growth of unwanted and deleterious organisms. The polyhydroxy organic compound could be glycerin (glycerol), a sugar alcohol, ethylene glycol, propylene glycol, erythritol, xylitol, or mannitol. The composition can also include an alkanoic acid (propionic acid), a strong base (KOH), and a mineral acid (phosphoric acid).

### CROSS-REFERENCES TO RELATED APPLICATIONS

This application is a divisional of U.S. patent application Ser. No. 14/783,626, filed Oct. 9, 2015, which is the U.S. National Stage Entry under § 371 of International Application No. PCT/US2014/033743, filed Apr. 11, 2014, which claims priority to U.S. Provisional Application No. 61/811,381 filed Apr. 12, 2013, the entire contents of which are incorporated herein in its entirety.

### BACKGROUND OF THE INVENTION

The agricultural industry relies on effective control of insects, plant pathogens, nematodes, and weeds, for bountiful and healthy crops. The control of certain forms of nematodes, for example, is an important factor in ensuring crop plant viability in the initial stages of crop growth and likewise for plant productivity and life span in both annual and perennial crops. Effective nematode control is particularly important in view of the ability of nematodes to persist in soil after crop removal.

Known methods for controlling nematodes include crop rotation, fallowing, the use of nematode-resistant crops, and soil fumigation. Of these, soil fumigation is the method that is the most economically feasible and the most widely used, and methyl bromide is the most widely used soil fumigant. Methyl bromide is a highly effective broad spectrum pesticide that is use both in both pre-harvest and post-harvest fumigation. A difficulty with methyl bromide however is its volatility, which results in the release of a significant amount of the chemical to the atmosphere when applied to soil. This reduces the amount of methyl bromide available for pesticidal action in the soil and also causes depletion of the ozone layer due to the reaction of ozone with the bromine atoms that are released when the methyl bromide undergoes photo-oxidation. The high volatility of methyl bromide also limits the effectiveness of this fumigant in heavy soils.

Calcium cyanamide has been used in Europe as an herbicide and in various parts of the world as a plant growth regulator. Liquid formulations of calcium cyanamide have been favored for their convenience, and research has shown hydrogen cyanamide to be the active ingredient of calcium cyanamide preparations. From its introduction in the 1950's, hydrogen cyanamide was used as a pre-emergence herbicide and a defoliant. The effectiveness of hydrogen cyanamide was attributable at least in part to the action of moist soil on plants in hydrolyzing calcium cyanamide to hydrogen cyanamide, which was not totally understood at the time. In the environment, hydrogen cyanamide decomposes to urea, followed by additional breakdown to ammoniacal forms of nitrogen and carbon dioxide. These metabolites become plant nutrients with their occurrence mediated by biological organisms and/or physical processes.

The decomposition of hydrogen cyanamide can be slowed by mixing hydrogen cyanamide with a stabilizer such as phosphoric acid or propionic acid. Stabilized hydrogen cyanamide can be a more effective herbicide or pesticide, but can also leach into groundwater or enter farm runoff before decomposing, with the result it does not act as a fertilizer in the location where it is applied. Moreover, the combination of propionic acid and hydrogen cyanamide is carbon-poor and cannot be readily metabolized by beneficial fungi and soil bacteria (e.g. actinomycetes) that compete with weeds, nematodes, and other pests in crop ecosystems.

When involved in composting, soil bacteria produce propionic acid and other organic acids, which facilitate the metabolism of carbohydrates and other organic matter. These bacteria can also metabolize compounds such as glycerin in the presence or absence of an exogenous organic acid. What is needed is a composition that reduces the growth of unwanted organisms and is easily decomposed. Surprisingly, the present invention meets this and other needs.

### BRIEF SUMMARY OF THE INVENTION

In some embodiments, the present invention provides a composition including cyanamide in an amount of from about 0.1% to about 20% (w/w), a polyhydroxy organic compound soluble in water, in an amount of from about 10% to about 90% (w/w), and water to 100%.

In some embodiments, the present invention provides a method of controlling organism growth, including contacting soil with a composition of the present invention, in an amount effective to control the growth of the organism.

In some embodiments, the present invention provides a method of promoting growth of fungus in soil, including contacting soil containing fungus with a composition of the present invention.

In some embodiments, the present invention provides a method of reducing pesticide-derived nitrates in soil, including contacting the soil with a composition of the pesticide and a polyhydroxy organic compound.

### BRIEF DESCRIPTION OF THE DRAWINGS

FIGS. 1A-1F show weeds per pot for pots treated with either cyanamide (“Solyver-Cyanamide” also “Solyver-C”) or urea (“Solyver-Urea” also “Solyver-U”) compositions. Data was collected for the total number of weeds, as well as for the weeds yellow nutsedge, crabgrass, teaweed, sicklepod and morning glory. FIG. 1A shows total weeds, FIG. 1B shows yellow nutsedge, FIG. 1C shows crabgrass, FIG. 1D shows teaweed, FIG. 1E shows sicklepod, and FIG. 1F shows morning glory.

FIGS. 2A-2F show weeds per pot for pots treated with either cyanamide+urea (“Plus Solyver-U”) or cyanamide alone (“Solyver-C”) compositions, with a constant rate of 3 g Solyver-U per 1 kg of soil, and increasing Solyver-C rate. Data was collected for the total number of weeds with an increasing amount of urea added. Data for the weeds yellow nutsedge, crabgrass, teaweed, sicklepod and morning glory all shows the combination of cyanamide and urea reduces the number of weeds compared to the urea alone composition, and that increasing levels of cyanamide generally results in a lower number of weeds. FIG. 2A shows total weeds, FIG. 2B shows yellow nutsedge, FIG. 2C shows crabgrass, FIG. 2D shows teaweed, FIG. 2E shows sicklepod, and FIG. 2F shows morning glory.

FIGS. 3A-3F show weeds per pot for pots treated with either cyanamide+urea (“Plus Solyver-C”) or urea alone (“Solyver-U”) compositions, with a constant rate of 3 g Solyver-C per 1 kg of soil, and an increasing rate of Solyver-U. Data was collected for the total number of weeds with an increasing amount of urea added. Data for the weeds yellow nutsedge, crabgrass, teaweed, sicklepod and morning glory all shows the combination of cyanamide and urea reduces the number of weeds compared to the urea alone composition, and that increasing levels of urea generally results in a lower number of weeds. FIG. 3A shows total weeds, FIG. 3B shows yellow nutsedge, FIG. 3C shows crabgrass, FIG. 3D shows teaweed, FIG. 3E shows sicklepod, and FIG. 3F shows morning glory.

FIGS. 4A-4D show the colonization index for trichoderma spp. FIG. 4A shows treatment with 10% Solyver-Urea (“Solyver CO”), 10 mL 10% Solyver-Cyanamide (“Solyver C1”), and 20 mL 10% Solyver-Cyanamide (“Solyver C2”), with increasing amount of urea added (“Solyver-U”); FIG. 4B shows treatment with either cyanamide+urea (“Plus Solyver-C”) or urea alone (“Solyver-U”), with increasing urea; FIG. 4C shows the same as FIG. 4B but 9 days instead of 15 days; and FIG. 4D shows treatment with either cyanamide+urea (“Plus Solyver-U”) or cyanamide alone (“Solyver-C”), with increasing Solyver-C.

FIGS. 5A-5B show nematodes per 100 mL of soil treated with 10% Solyver-Urea (“Solyver CO”), 10 mL 10% Solyver-Cyanamide (“Solyver C1”), and 20 mL 10% Solyver-Cyanamide (“Solyver C2”), with increasing amount of urea added (“Solyver-U”). FIG. 5A shows R. reniformis, and FIG. 5B shows microbivorous nematodes.

FIGS. 6A-6C show nematodes per 100 mL of soil treated with cyanamide+urea (“Plus Solyver-C”) or urea alone (“Solyver-U”) compositions, with increasing urea rate (“Solyver-U”). Data was collected for the number of nematodes with an increasing amount of urea added. Data shows the combination of cyanamide and urea reduces the number of nematodes compared to the urea alone composition, and that increasing levels of urea generally results in a lower number of nematodes. FIG. 6A shows R. reniformis, FIG. 6B shows dorylaimida, and FIG. 6C shows microbivorous nematodes.

FIGS. 7A-7C show nematodes per 100 mL of soil treated with cyanamide+urea (“Plus Solyver-U”) or cyanamide alone (“Solyver-C”) compositions, with an increasing cyanamide rate of addition (“Solyver-C”). Data was collected for the number of nematodes with an increasing amount of Solyver-C added. Data shows the combination of cyanamide and urea reduces the number of nematodes compared to the urea alone composition, and that increasing levels of cyanamide generally results in a lower number of nematodes. FIG. 7A shows R. reniformis, FIG. 7B shows dorylaimida, and FIG. 7C shows microbivorous nematodes.

FIGS. 8A-8D show nematode test data for various amounts and combinations of Solyver-C and Solyver-U compositions. FIG. 8A shows data for R. reniformis, FIG. 8B shows data for reniform, dorylaimoid and saprophagous, FIG. 8C shows data for reniform, dorylaimoid and saprophagous, and FIG. 8D shows data for nematodes per root for reniform and saprophagous.

FIGS. 9A-C show nematodes per 100 mL of soil treated with either cyanamide (“Solyver-Cyanamide”) or urea (“Solyver-Urea”) compositions. FIG. 9A shows R. reniformis, FIG. 9B shows dorylaimida, and FIG. 9C shows microbivorous nematodes.

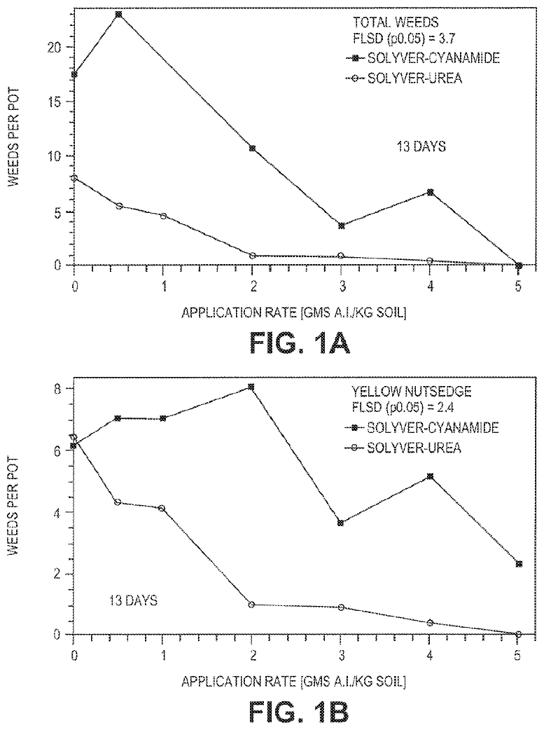

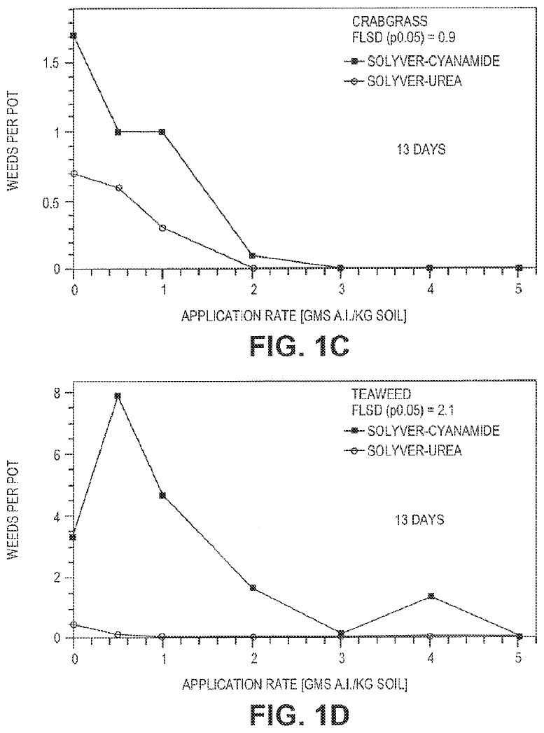

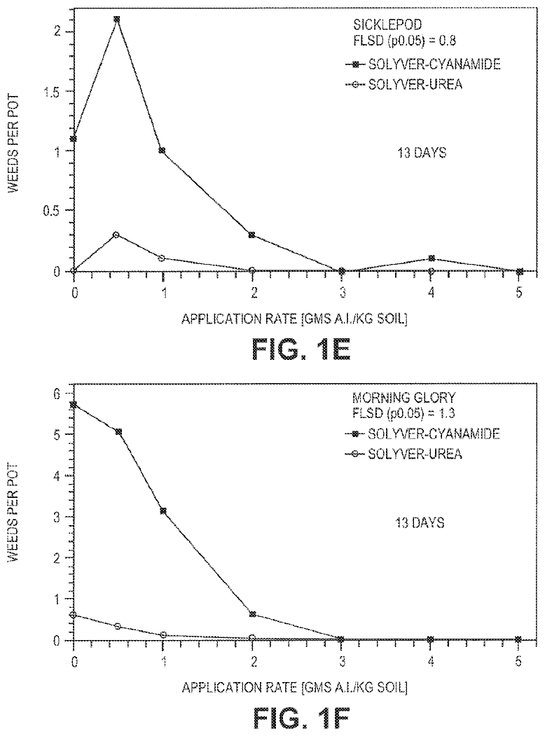

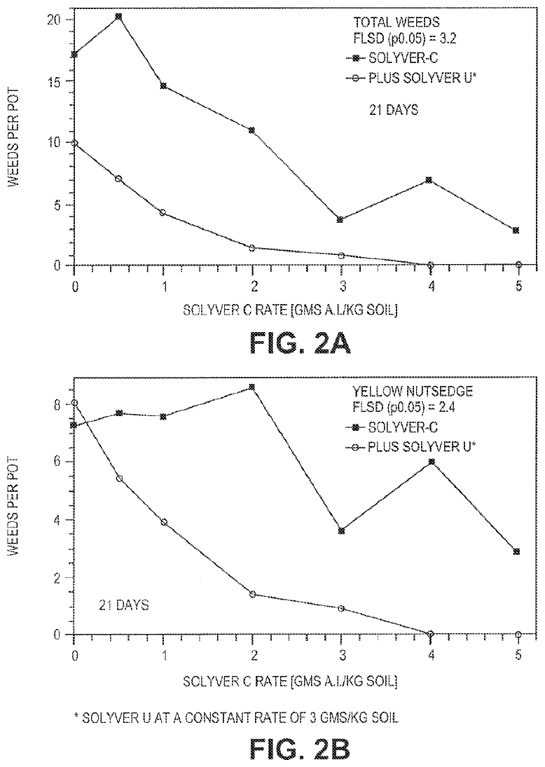

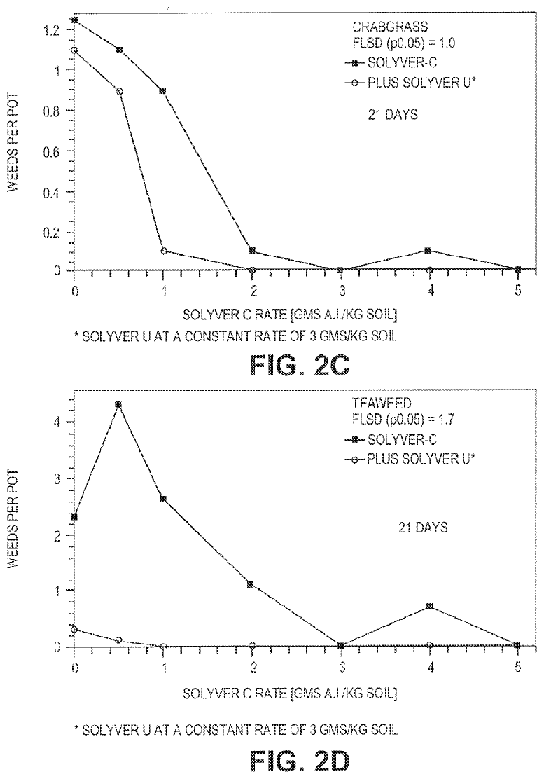

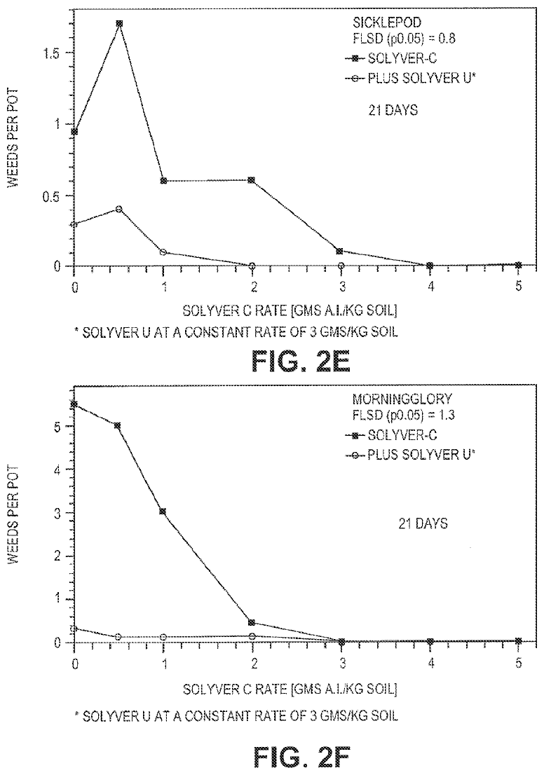

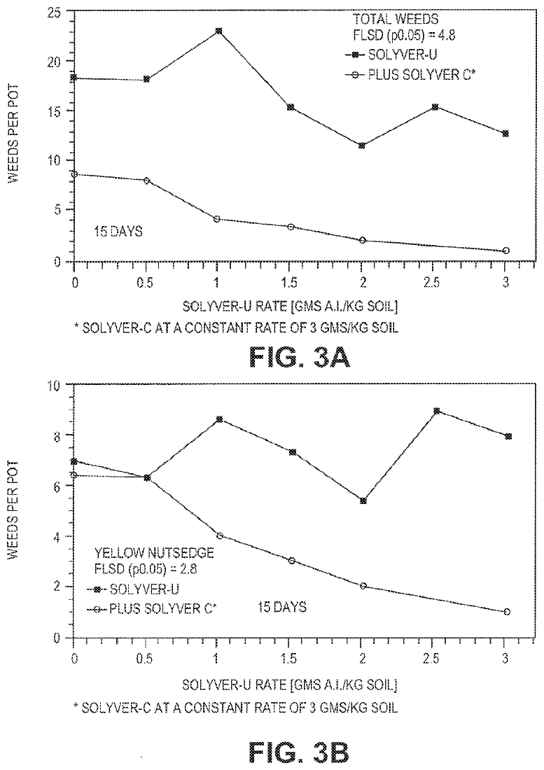

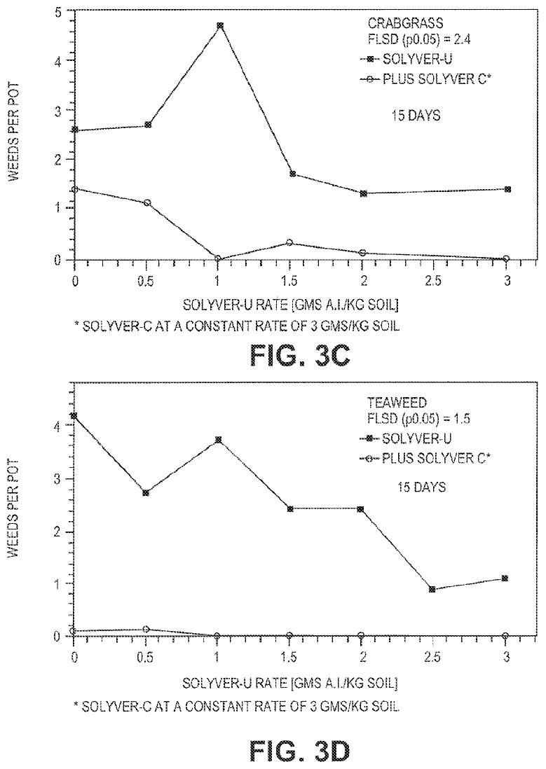

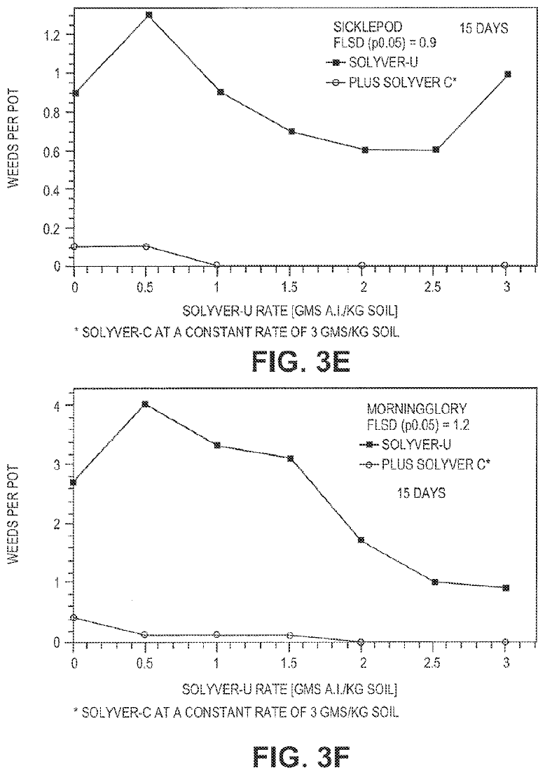

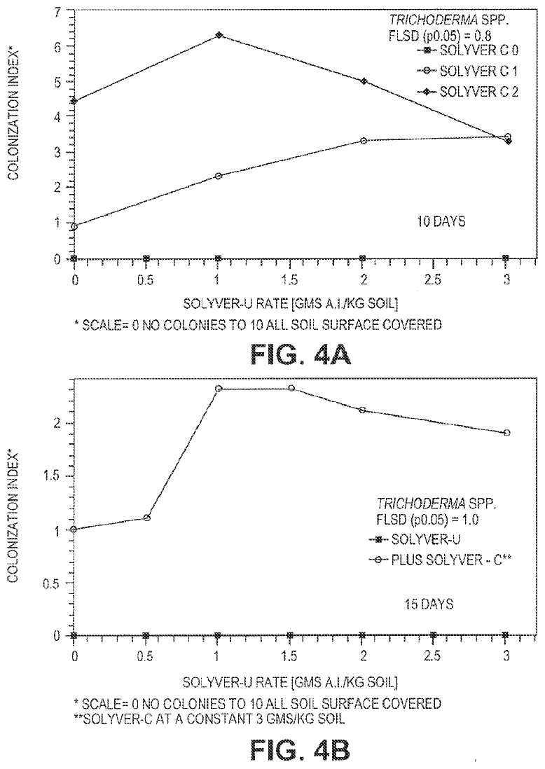

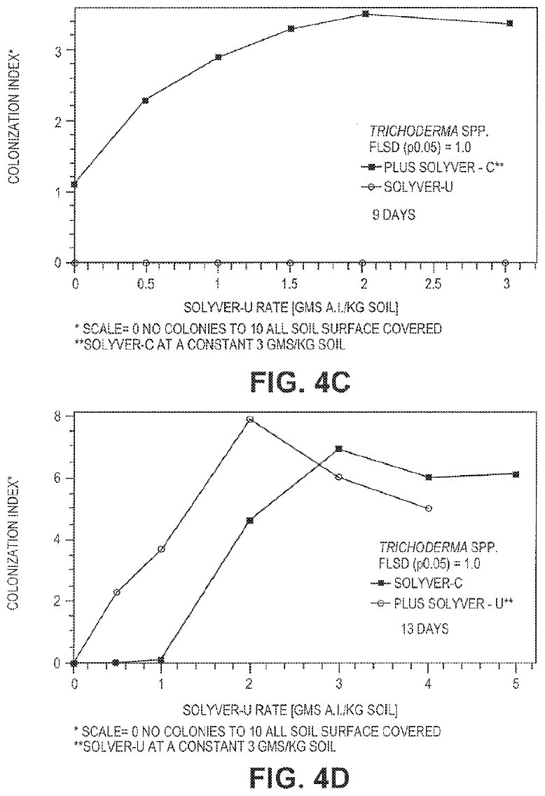

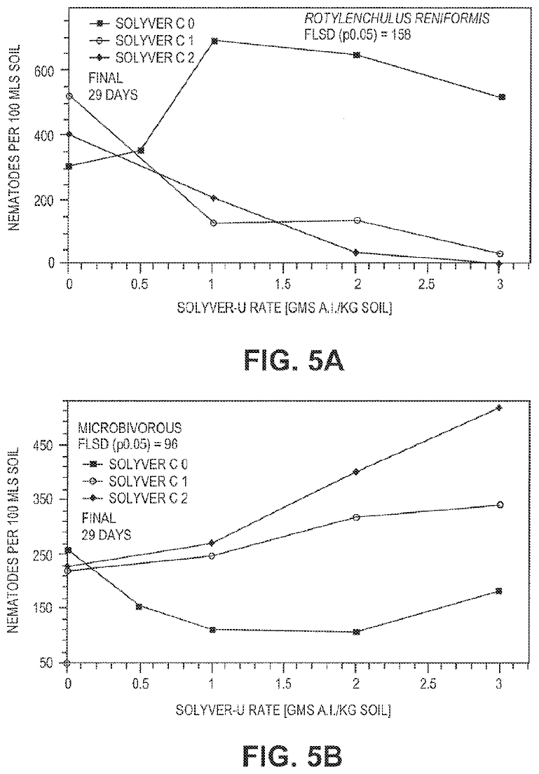

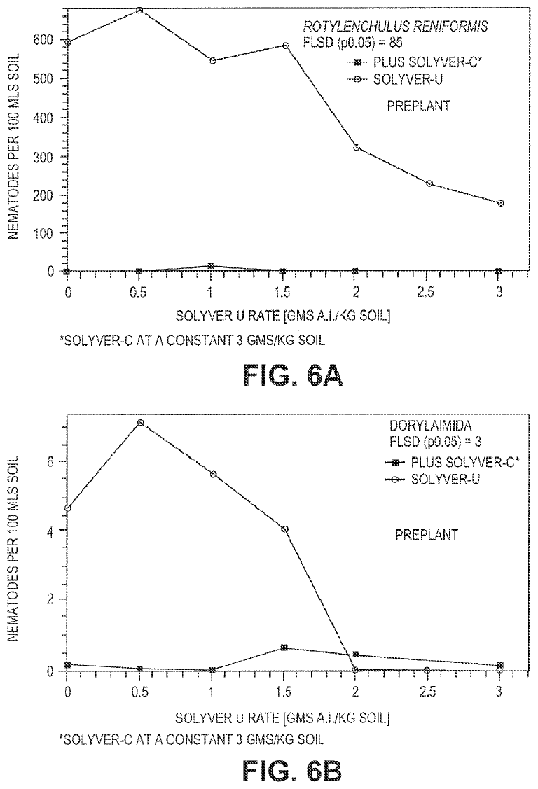

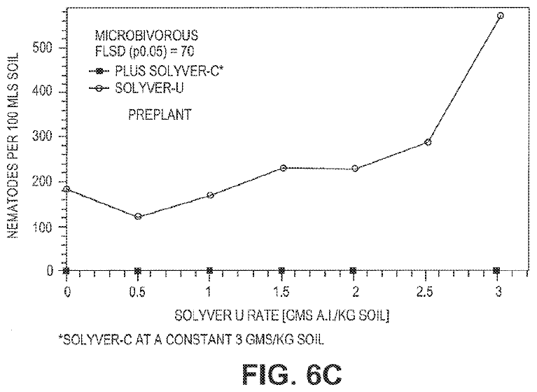

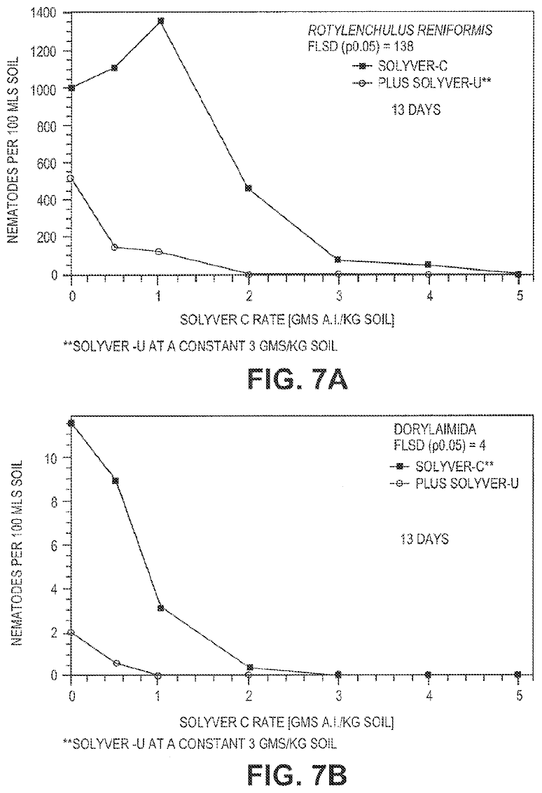

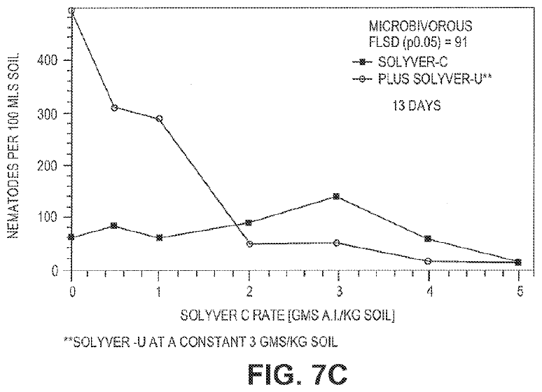

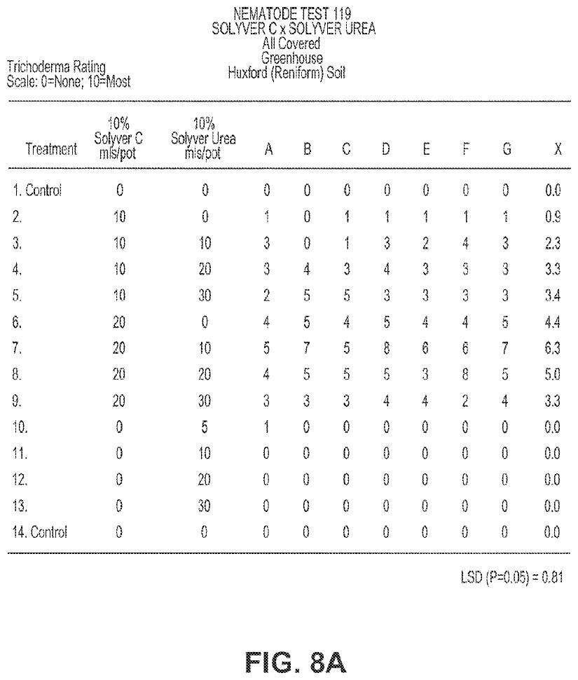

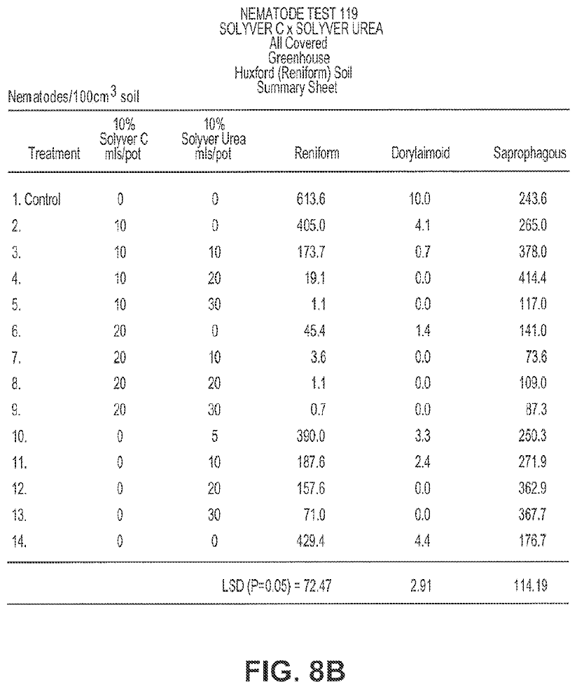

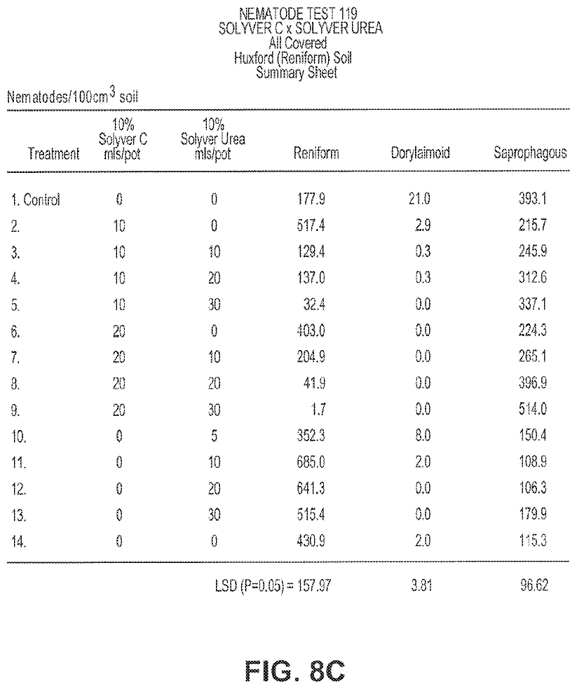

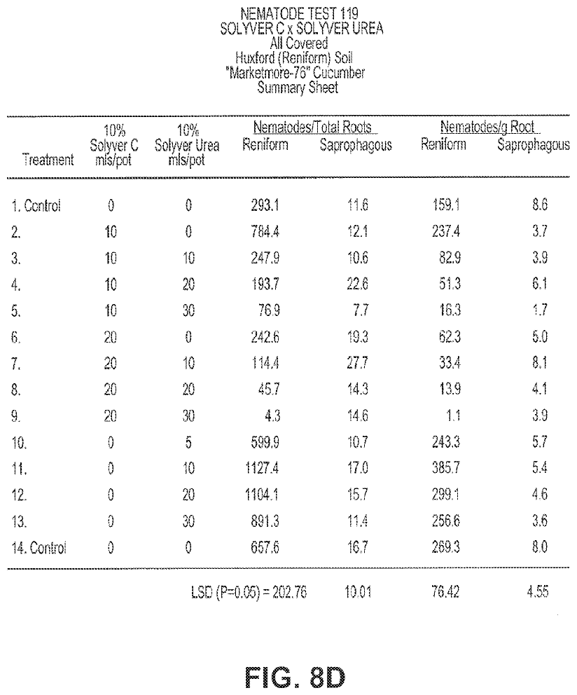

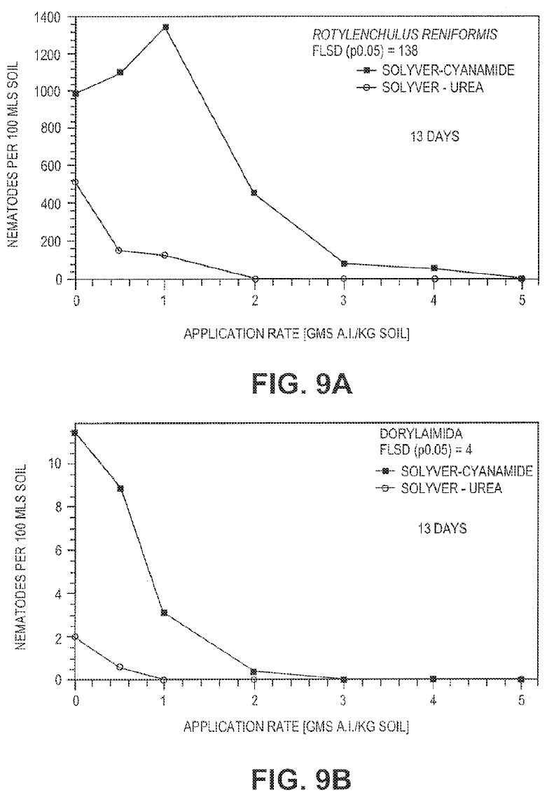

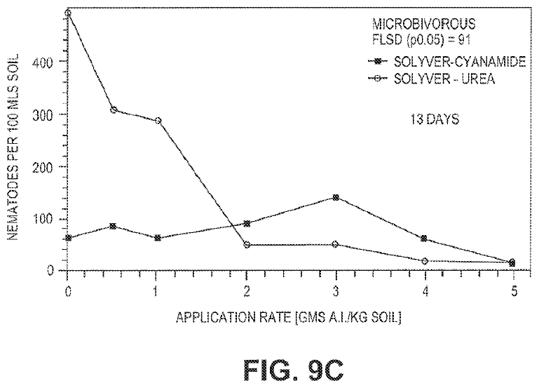

### DETAILED DESCRIPTION OF THE INVENTION

### I. General

The present invention describes compositions of cyanamide with glycerin for controlling the growth of unwanted pests and weeds, such as nematodes and yellow nutsedge, among others. The composition can also include propionic acid, sodium hydroxide and phosphoric acid. Urea can also be included in the composition and provides synergistic effects for controlling the growth of unwanted pests and weeds.

### II. Definitions

“Cyanamide” refers to hydrogen cyanamide or calcium cyanamide. Hydrogen cyanamde is an organic compound of the formula H₂N—C≡N, and can also be called cyanogenamide or carbodiimide. Calcium cyanamide is a calcium salt of the formula Ca²⁺[N═C═N]²⁻.

“Polyhydroxy organic compounds” refers to organic compounds having multiple hydroxyl groups. The polyhydroxy organic compounds can have 2, 3, 4, 5, 6 or more hydroxy groups. Moreover, the polyhydroxy organic compound can have any suitable molecular weight, but is typically less than 1000 g/mol, or less than 500 g/mol, or less than 250 g/mol. Representative compounds include, but are not limited to, glycerin (also called glycerine and glycerol), ethylene glycol, propylene glycol, erythritol, xylitol, mannitol, other sugar alcohols, and various sugars (e.g. glucose and fructose).

“Alkanoic acids” refers to compounds comprising one or more carboxyl groups covalently linked to a saturated, aliphatic alkane. The alkanoic ac can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. Representative alkanoic acids include, but are not limited to, formic acid, acetic acid, propanoic acid, and butyric acid. Other alkanoic acids having two carboxyl groups include, but are not limited to, malonic acid and succinic acid. Both monocarboxylic acids and dicarboyxlic acids are useful alkanoic acids in the present invention.

“Base” refers to a compound that accepts a proton (Hf), under the Bronsted-Lowry definition, or donates a pair of electrons, under the Lewis definition. Bases can have different strengths and can be classified as strong or weak depending on their ability to deprotonate weak acids in an acid-base reaction. For example, hydroxides of alkali and alkaline earth metals are strong bases. Strong bases include, but are not limited to, potassium hydroxide, barium hydroxide, cesium hydroxide, sodium hydroxide, calcium hydroxide, and lithium hydroxide, amonth others.

“Acid” refers to a compound that is capable of donating a proton (Hf) under the Bronsted-Lowry definition, or is an electron pair acceptor under the Lewis definition. Acids useful in the present invention are Bronsted-Lowry acids that include, but are not limited to, alkanoic acids or carboxylic acids (formic acid, acetic acid, citric acid, lactic acid, oxalic acid, etc.), sulfonic acids and mineral acids, as defined herein. Mineral acids are inorganic acids such as hydrogen halides (hydrofluoric acid, hydrochloric acid, hydrobromice acid, etc.), halogen oxoacids (hypochlorous acid, perchloric acid, etc.), as well as sulfuric acid, nitric acid, phosphoric acid, chromic acid and boric acid. Sulfonic acids include methanesulfonic acid, benzenesulfonic acid, p-toluenesulfonic acid, triflouromethanesulfonic acid, among others.

“Buffer” refers to any inorganic or organic acid or base that resists changes in pH and maintains the pH around a desired point. Buffers useful in the present invention include, but are not limited to, sodium hydroxide, potassium hydroxide, phosphoric acid, and mixtures thereof. Other buffers include tris(hydroxymethyl)aminomethane (Tris), 4-(2-hydroxyethyl)-1-piperazineethanesulfonic acid (HEPES), 3-(N-morpholino)propanesulfonic acid (MOPS), and mixtures thereof. For example, a buffer can be a combination of a strong base and an acid, such as potassium hydroxide and phosphoric acid.

“Urea” refers to a chemical compound of the formula H₂N—(C═O)—NH₂.

“Controlling organism growth” refers to reducing the growth rate of the organisms, slowing maturation of the organisms, slowing reproduction of the organisms, or incapacitating or reducing the viable population of the organisms. Means for controlling growth can be exercised on any portion of the organism (e.g. a specific organ) or on the organism as a whole, or merely in the environment in which the organism lives. Control of growth can be measured in terms of the number of organisms, rate or timing of growth, the extent of growth, or whether certain manifestations of growth (e.g. flowers on a plant) appear. Compared with an organism whose growth is not controlled, the amount of control achieved for an organism can be absolute or by degree (for example, increasing the number of flowers on a plant by 5%).

“Contacting” refers to bringing two or more objects or substances into physical contact. For example, contacting a first substance with a second substance may involve touching the two substances to each other, mixing the two substances together, burying or submerging one substance in the other, or passing one substance over or through the other. To contact one object or substance with another, the objects or substances may be brought together in any way feasible given their phases of matter and other material properties.

“Soil” refers to a medium in which plants can grow. Soil can comprise decaying organic matter, humus, clay, sand, silt, stones, animal waste products, and water, for example. As is known in the art, soil can vary as a function depth from the surface, topography, and location, among other factors.

“Weed” refers to a plant whose growth in an agricultural context is not desired. A weed growing at the same time and place as a cultivated crop can compete with the crop for resources, such as nutrients, water, or sunlight, and hinder or reduce the growth of the crop. Accordingly, the growth of weeds may be controlled (see definition of ‘controlling organism growth’). Representative weeds include yellow nutsedge, crabgrass, teaweed, sicklepod, and morning glory.

“Nematode” refers to a roundworm belonging to the phylum Nematoda or Nemathelminthes. Nematodes can be deleterious or beneficial. Representative nematodes include plant parasites such as Rotylenchulus reniformis (“reniform”), and microbivorous nematodes such as those belonging to the order Rhabditida.

“Fungus” refers to any organism belonging to the kingdom Fungi. The fungus can be beneficial or deleterious. Representative fungi include, but are not limited to, trichoderma spp.

“Pesticide” refers to a substance, e.g. a chemical compound, that can be used to incapacitate or control the growth of one or more organisms. The organism can be an insect, worm, rodent, bird or any other member of the kingdom Animalia. Pesticide can also include herbicides, i.e. substances that incapacitate or control the growth of plants. A pesticide may be “broad-spectrum” and affect many kinds of animals or plants, or may be “selective” and affect only certain kinds of animals or plants. The pesticide can be applied directly to a target organism, or to the environment in which the organism lives, for example an area of soil or a body of water. A pesticide can also be applied to a non-target organism, for example a plant, with the goal of incapacitating organisms such as insects that reside on the non-target organism. A pesticide can be applied in any form of matter, for example as a solid, liquid, or gas. When in liquid form, a pesticide can be part of a solution, suspension, emulsion or colloid.

“Nitrates” refers to the nitrate ion (NO₃⁻), nitric acid (HNO₃), and salts of nitrate (e.g., potassium nitrate, KNO₃). Nitrates can be found in soils and can result from the decomposition of urea and ammonia from biological sources.

### III. Compositions

The present invention describes treatment and eradication of weeds, nematodes and fungi from plants using cyanamide compositions. In some embodiments, the present invention provides a composition including cyanamide in an amount of from about 0.1% to about 20% (w/w), a polyhydroxy organic compound soluble in water, in an amount of from about 10% to about 90% (w/w), and water to 100%.

Cyanamide useful in the present invention can be cyanamide, hydrogen cyanamide or calcium cyanamide. Hydrogen cyanamide can be obtained commercially, for example as a purified solid or as the liquid composition DORMEX® (50% hydrogen cyanamide by weight, sold by AlzChem AG, Trostberg, Germany). Alternatively, hydrogen cyanamide can be prepared from dissolution or hydrolysis of calcium cyanamide, which is commercially available from AlzChem, Sigma-Aldrich (St. Louis, Mo.), and other vendors. Cyanamide can serve as a fertilizer for some crops, and can also act as a pesticide or herbicide, suppressing the growth of unwanted organisms such as weeds or nematodes that may compete with crops for resources. In some embodiments, the cyanamide can be hydrogen cyanamide or calcium cyanamide. In other embodiments, the cyanamide can be hydrogen cyanamide. In some other embodiments, the cyanamide can be calcium cyanamide.

Cyanamide can be present in the composition in any suitable amount, such as from about 0.1% to about 20% (w/w). The cyanamide can also be present in an amount of from about 1% to about 20% (w/w), or from about 1% to about 10% (w/w), or from about 1% to about 5% (w/w), or from about 5% to about 10% (w/w). The cyanamide can also be present in the composition in an amount of about 1%, 2, 3, 4, 5, 6, 7, 8, 9 or 10% (w/w). In some embodiments, the cyanamide can be present in an amount of about 3% (w/w). In other embodiments, the cyanamide can be present in an amount of about 6% (w/w).

Polyhydroxy organic compounds useful in the compositions of the present invention can be straight-chain alkanes or cycloalkanes substituted with two or more hydroxyl groups, and are generally soluble in water. Representative polyhydroxy organic compounds include, but are not limited to, sugars, sugar alcohols, ethylene glycol, glycerol, glycerin, propylene glycol, erythritol, threitol, arabitol, ribitol, xylitol, mannitol, sorbitol, galactitol and iditol. In some embodiments, the polyhydroxy organic compound can be glycerin, ethylene glycol, propylene glycol, erythritol, xylitol, or mannitol. In other embodiments, the polyhydroxy organic compound can be glycerin. In some other embodiments, the polyhydroxy organic compound can be bioglycerin. Without being bound by any theory, the polyhydroxy compound can serve as a metabolizable carbon source for organisms to which the composition is applied.

The polyhydroxy organic compounds can be obtained by any suitable means, such as from commercial sources, from synthetic sources, or as by-products of other processes. For example, glycerin can be obtained from the production of a number of processes, including the production of biodiesel fuel. For example, approximately 100 kg of glycerin can be produced per 1000 kg biodiesel. Glycerin obtained along with biodiesel is termed ‘bioglycerin’, and in some embodiments the polyhydroxy organic compound is bioglycerin.

The polyhydroxy organic compound can be present in any suitable amount in the composition of the present invention, such as from about 10% to about 90% (w/w). The polyhydroxy organic compound can also be present in an amount of from about 25% to about 75% (w/w), or from about 35% to about 65%, or from about 45% to about 60%, or from about 50% to about 60% (w/w). The polyhydroxy organic compound can also be present in the composition in an amount of about 50%, 51, 52, 53, 54, 55, 56, 57, 58, 59 or 60% (w/w). In some embodiments, the polyhydroxy organic compound can be present in an amount of about 54% (w/w).

The composition of the present invention can also include any suitable organic acid. Representative organic acids include C₁₋₆ alkanoic acid, i.e. a straight-chain carboxylic acid having between one and six carbon atoms, the corresponding partially saturated alkanoic acids, and aromatic organic acids. Examples of C₁₋₆ alkanoic acids include, but are not limited to, monocarboxylic acids (e.g. formic acid, acetic acid, propanoic acid, butyric acid), and dicarboxylic acids (e.g. malonic acid, succinic acid). Alkanoic acids are available from many commercial sources. In some embodiments, the composition also includes a C₁₋₆ alkanoic acid. In other embodiments, the alkanoic acid can be formic acid, acetic acid, propanoic acid, malonic acid, butyric acid or succinic acid. In some other embodiments, the alkanoic acid can be formic acid, acetic acid, propanoic acid or butyric acid. In still other embodiments, the alkanoic acid can be propanoic acid.

When the composition includes an alkanoic acid, any suitable of alkanoic acid can be used in the composition. For example, the alkanoic acid can be present in an amount of from about 1% to about 25% (w/w), or from about 5 to about 15% (w/w), or from about 6% to about 12% (w/w). The alkanoic acid can also be present in the composition in an amount of about 5%, 6, 7, 8, 9, 10, 11, 12, 13, 14 or 15% (w/w). The alkanoic acid can also be present in the composition in an amount of about 8.0%, 8.1, 8.2, 8.3, 8.4, 8.5, 8.6, 8.7, 8.8, 8.9 or 9.0% (w/w). Without being bound by any theory, the alkanoic acids can stabilize the cyanamide composition, slowing the decomposition of hydrogen cyanamide (see e.g. U.S. Pat. No. 7,572,460, incorporated herein in its entirety).

The composition of the present invention can also include any suitable base. For example, the base can be a strong base such as sodium hydroxide (NaOH) or potassium hydroxide (KOH). In some embodiments, the composition can also include a strong base. In other embodiments, the strong base can be NaOH or KOH. In some other embodiments, the strong base can be KOH.

When a base is present in the composition of the present invention, any amount of base can be suitable. For example, the base can be present in an amount of from about 1% to about 25% (w/w) of the base, or from about 1% to about 10%, or from about 1% to about 5% (w/w). The base can also be present in the composition in an amount of about 1%, 2, 3, 4, 5, 6, 7, 8, 9 or 10% (w/w). In some embodiments, the base can be present in an amount of about 3% (w/w). The base can be present as a concentrated solution of base in water, or a more dilute solution. For example, the base can be present as a 25%, 35, 45, 50, 55, 65 or 75% base in water solution. In some embodiments, the base can be present in an amount of from about 7% (w/w), as a 45% potassium hydroxide solution.

The composition of the present invention can also include an acid such as a mineral acid. Mineral acids useful in the compositions of the present invention include, but are not limited to, hydrochloric acid, nitric acid, phosphoric acid, sulphuric acid, boric acid, or perchloric acid. In some embodiments, the composition of the present invention includes an acid. In other embodiments, the composition includes a mineral acid. In some other embodiments, the composition includes a mineral acid that can be hydrochloric acid, nitric acid, phosphoric acid, sulphuric acid, boric acid, or perchloric acid. In yet other embodiments, the mineral acid can be phosphoric acid.

The mineral acid can be present in the composition in any suitable amount. For example, the mineral acid can be present in an amount of from about 0.1% to about 10% (w/w), or from about 0.1% to about 5% (w/w), or from about 1% to about 5% (w/w). The mineral acid can also be present in an amount of about 1.0%, 1.25, 1.5, 1.75, 2.0, 2.25, 2.5, 2.75, 3.0, 3.25, 3.5, 3.75, 4.0, 4.25, 4.5, 4.75 or 5.0% (w/w). The mineral acid can be a concentrated solution, or a more dilute solution. For example, concentrated phosphoric acid can be 85% phosphoric acid in water (w/w). Other concentrations are useful, such as 50%, 55, 60, 65, 70, 75, 80 or 85% phosphoric acid in water (w/w). In some embodiments, the phosphoric acid can be present in the composition in an amount of about 3% (w/w), as a 75% phosphoric acid solution.

The composition of the present invention can have any suitable pH. For example, the composition can be from about 4 to about 10, or from about 4 to about 7, or from about 5 to about 7. The pH of the composition can also be less than about 5, 6 or 7. The pH of the composition can also about 5, 6 or 7. In some embodiments, the composition can have a pH of less than about 6. In other embodiments, the pH can be about 5. The pH can be maintained at a particular value by any means in the art. For example, the composition can include any suitable buffer.

In some embodiments, the present invention provides a composition including cyanamide, in an amount of about 6% (w/w), glycerin, in an amount of about 54% (w/w), propanoic acid, in an amount of about 8.6% (w/w), a 45% potassium hydroxide solution, in an amount of about 7% (w/w), a 75% phosphoric acid solution, in an amount of about 3% (w/w), and water to 100%.

The composition can also include urea in any suitable amount. For example, urea can be present in an amount of from about 1% to about 15% (w/w), or from about 1% to about 10% (w/w), or from about 1% to about 5% (w/w), or from about 5% to about 10% (w/w). The urea can also be present in an amount of about 1%, 1.5, 2.0, 2.5, 3.0, 3.5, 4.0, 4.5, 5.0, 5.5, 6.0, 6.5, 7.0, 7.5, 8.0, 8.5, 9.0, 9.5 or about 10% (w/w). In some embodiments, the urea can be present in an amount of about 6.8% (w/w). In other embodiments, the urea can be present in an amount of about 3.4% (w/w).

The compositions of the present invention can include other components, such as fertilizers, pesticides (herbicides, insecticides, or fungicides, or combinations thereof), additives, diluents, stabilizers, colorants, buffers, plant growth regulators, defoliants, etc. Examples of such adjuvants are formulating aids, buffers and other stabilizers, solubilizing agents, and dispersing agents. These materials are well known in the agricultural formulations industry and readily available from suppliers of agricultural chemicals. Any of these additional substances can be included in the compositions of the present invention.

### IV. Methods

The present invention also provides methods of controlling the growth of unwanted and undesirable organisms in soil, using the composition of the present invention. In some embodiments, the present invention provides a method of controlling organism growth, including contacting soil with a composition of the present invention, in an amount effective to control the growth of the organism.

The organism whose growth is controlled can be any unwanted or undesirable organisms, such as organisms causing harm to crops or plants. These organisms include, but are not limited to, insects, nematodes, fungi, and undesired vegetation. The term “undesired vegetation” denotes non-crop plant species that otherwise tend to grow in the areas where crops are planted, and includes both volunteer crops and weeds. The undesired vegetation whose control is of greatest interest in the practice of this invention are weeds, and primarily those weeds associated with common crops such as corn, green peppers, tomatoes, soybeans, and vegetables in general, as well as cotton, sorghum, wheat, alfalfa, various ornamentals, and various turf grasses.

The growth of any type of weed can be controlled using the method of the present invention. For example, weeds include barnyard grass, Bermuda grass, bindweed, burdock, chickweed, crabgrass, dandelion, goldenrod, kudzu, milk thistle, morning-glory, poison ivy, ragweed, sicklepod, sorrel, St. John's wort, sumac, teaweed, and yellow nutsedge. In some embodiments, the weed can be at least one of yellow nutsedge, crabgrass, teaweed, sicklepod, or morning-glory. In other embodiments, the weed can be yellow nutsedge.

Other organisms whose growth can be controlled by the method of the present invention include the nematodes. Nematodes that are deleterious to crop growth are plant-parasitic nematodes that include reniform nematodes (Rotylenchulus reniformus), spiral nematodes (Helicotylenchus dihystera), root-knot nematodes (Meloidogyne arenaria, M. naasi and M. incognita), stubby root nematodes (Paratrichodorus minor), stunt nematodes (Tylenchorhynchus claytoni), and others. These are distinct from nematodes that are beneficial to crop growth, examples of which are microbivorous (free-living) nematodes and other nematodes, such as those of the Dorylaimida order, that feed on algae, fungi, and other nematodes. Representative nematodes include nematodes in the Rotylenchulus family, such as Rotylenchulus reniformis, reniform nematode. Reniform nematodes refer to nematodes that penetrate the root cortex of the plant. In some embodiments, the nematode can be Rotylenchulus reniform. Representative organisms include weeds and nematodes. In some embodiments, the organism can be a weed or nematode.

The method of the present invention can control the growth of multiple organisms simultaneously. For example, the growth of weeds and nematodes can be controlled by contacting soil with the composition of the present invention.

The methods and compositions of the present invention can also be used to promote the growth of some organisms while simultaneously controlling the growth of other organisms. Organisms whose growth can be promoted include beneficial organisms such as fungi. Representative fungi include, but are not limited to, fungi of the genera trichoderma and fusarium. In some embodiments, the present invention provides a method of promoting the growth of fungus in soil, including contacting the soil containing fungus with a composition of the present invention. In some embodiments, the fungi can be from the genera trichoderma or fusarium.

Any type of soil can be treated with the compositions of the invention to control the growth of unwanted organisms, or to promote the growth of other organisms. Representative soils include, but are not limited to, sandy soils, loamy soils, clays, silt, and combinations such as sandy loam, silty loam, sandy clay, and the like.

The soil in the methods of the present invention can be contacted with the composition of the present invention by any suitable means. For example, the composition can be sprayed, dripped, etc., onto the soil. Alternatively, the composition can be applied as a solid formulation (see, for example, U.S. Pat. No. 8,197,834, incorporated herein by reference). The soil can also be contacted at least once with the composition of the present invention, or multiple times. For example, the soil can be contacted 1, 2, 3, 4, or more times. When multiple applications are used, the different applications of the composition can be separated by minutes, hours, days, weeks or months. When the formulations are used for controlling undesirable vegetation, effective results can be achieved with both pre-emergence application (application to the soil before the undesirable vegetation emerges from the soil surface) and post-emergence application (application to the undesirable vegetation that has already emerged).

Any suitable amount of the composition can be applied to the soil to control organism growth, or promote the growth of fungus. For example, the composition can be applied in an amount sufficient to apply cyanamide in an amount of from about 1 g/acre to about 1,000 g/acre, or from about 10 g/acre to about 500 g/acre, or from about 25 g/acre to about 500 g/acre, or from about 50 g/acre to about 250 g/acre. The composition can also be applied in an amount sufficient to apply cyanamide in an amount of about 1 g/acre, 10, 25, 50, 100, 150, 200, 250, 500 or 1,000 g/acre.

The present invention also provides a method of reducing pesticide-derived nitrates in soil. Without being bound by any particular theory, the polyhydroxy organic compound of the composition provides a carbon source that accelerates decomposition of cyanamide and uptake by the plant, whereas without the polyhydroxy organic compound, the cyanamide be converted to nitrates and nitrites that would pass through the root layer of the soil and eventually accumulate in the water table. The polyhydroxy organic compound, therefore, can act to accelerate cyanamide decomposition and uptake by the plant, reducing accumulation of nitrates and nitrites in the water table.

### V. Examples

### Example 1. Preparation of Cyanamide Compositions

The components were combined in the following amounts:

| | Solyver-Cyanamide | Solyver-Urea | Solyver-C + |
|---|---|---|---|
| | or Solyver-C | or Solyver-U | Solyver-U² |
| Component | (% w/w) | (% w/w) | (% w/w) |
| Hydrogen | 100 g | — | 100 g |
| cyanamide | (12.4%) | | (6.2%) |
| (DORMEX ®)¹ | | | |
| Urea | — | 110 g | 110 g |
| | | (13.5%) | (6.8%) |
| Glycerin | 436 g | 436 g | 872 g |
| | (54%) | (53%) | (53.7%) |
| Propanoic acid | 70 mL | 70 mL | 140 mL |
| | (8.6%) | (8.5%) | (8.5%) |
| KOH | 38 mL 45% | 38 mL 45% | 76 mL 45% |
| | solution | solution | solution |
| | (7%) | (7%) | (7%) |
| Phosphoric | 15 mL 75% | 15 mL 75% | 30 mL 75% |
| acid | solution | solution | solution |
| | (3%) | (3%) | (3 %) |
| Water | 120 mL | 120 mL | 240 mL |
| | (15%) | (15%) | (14.8%) |

¹The amount shown is the amount of DORMEX ®, and because DORMEX ® is 50% water (w/w), 100 g of DORMEX ® is 50 g hydrogen cyanamide.
²The combined mixtures are also referred to as “plus Solyver-C” when Solyver-U is the base composition, or “plus Solyver-U” when Solyver-C is the base composition.

### Example 2. Controlling Organism Growth

The compositions of Example 1 were applied to the soil surface in each pot, at 100 mL of combined dilution per pot. The dilutions were selected to achieve target application rates expressed in milligrams of the treatment chemical per kilogram of soil, with 1 milligram of treatment chemical per kilogram of soil being approximately equal to 2 kilograms of the chemical per hectare of soil or 2 pounds of the chemical per acre of soil. Immediately after the treatment chemicals were applied, each pot was covered by a thick (1.5 mil), clear, low-density polyethylene bag. After twelve days, the bags were removed and soil samples were taken from each pot for nematological analysis by the salad bowl technique of Rodriguez-Kabana, R., and M. H. Pope, Nematropica, 11: 175-186 (1981). Results are shown in the Figures.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1.-19. (canceled)

20. A method of controlling organism growth, comprising contacting soil with a composition comprising:
cyanamide, in an amount of from 0.1% to about 20% (w/w);
a polyhydroxy organic compound soluble in water, in an amount of from about 10% to about 90% (w/w); and
water to 100%,
in an amount effective to control the growth of the organism.

21. The method of claim 20, wherein the organism comprises a weed or a nematode.

22. The method of claim 21, wherein the weed comprises at least one member selected from the group consisting of yellow nutsedge, crabgrass, teaweed, sicklepod, and morning-glory.

23. The method of claim 21, wherein the weed comprises yellow nutsedge.

24. The method of claim 21, wherein the nematode comprises Rotylenchulus reniform.

25. A method of promoting growth of fungus in soil, comprising contacting soil containing fungus with a composition comprising:
cyanamide, in an amount of from 0.1% to about 20% (w/w);
a polyhydroxy organic compound soluble in water, in an amount of from about 10% to about 90% (w/w); and
water to 100%.

26. The method of claim 25, wherein the fungus is selected from the group consisting of the genera trichoderma and the genera fusarium.

27. A method of reducing pesticide-derived nitrates in soil, comprising contacting the soil with a composition comprising the pesticide and a polyhydroxy organic compound.

28. The method of claim 27, wherein the composition comprises:
cyanamide, in an amount of from 0.1% to about 20% (w/w);
a polyhydroxy organic compound soluble in water, in an amount of from about 10% to about 90% (w/w); and
water to 100%.

29. The method of claim 27, wherein the composition comprises:
urea, in an amount of about 6.8% (w/w)
cyanamide, in an amount of about 3% (w/w);
glycerin, in an amount of about 54% (w/w);
propanoic acid, in an amount of about 8.5% (w/w);
a 45% potassium hydroxide solution, in an amount of about 7% (w/w);
a 75% phosphoric acid solution, in an amount of about 3% (w/w); and
water to 100%.
